(19) United States
(12) Patent Application Publication
(10) Pub. No.: US 2025/0183374 A1
(43) Pub. Date: Jun. 5, 2025

(54) SECONDARY BATTERY

(71) Applicant: MURATA MANUFACTURING CO., LTD., Kyoto (JP)

(72) Inventor: Kohei AWAYA, Kyoto (JP)

(21) Appl. No.: 19/039,115

(22) Filed: Jan. 28, 2025

Related U.S. Application Data
(63) Continuation of application No. PCT/JP2023/044176, filed on Dec. 11, 2023.

(30) Foreign Application Priority Data
Dec. 27, 2022 (JP) 2022-209304

(51) Int. Cl. H01M 10/0569; H01M 10/0525; H01M 10/0567; H01M 50/105

(52) U.S. Cl. CPC H01M 10/0569; H01M 10/0525; H01M 10/0567; H01M 50/105; H01M 2300/0034; H01M 2300/0042

(57) ABSTRACT

A secondary battery is provided and includes an exterior member having flexibility, and a positive electrode, a negative electrode, and an electrolytic solution that are housed in the exterior member. The electrolytic solution contains a solvent and an electrolyte salt, and the solvent contains propyl acetate and propyl propionate. The ratio of the content of propyl acetate in the solvent to the sum of the content of propyl acetate in the solvent and the content of propyl propionate in the solvent is 0.1 or more and 0.5 or less.

### CROSS REFERENCE TO RELATED APPLICATIONS

The present application is a continuation of PCT patent application no. PCT/JP2023/044176, filed on Dec. 11, 2023, which claims priority to Japanese patent application no. 2022-209304, filed on Dec. 27, 2022, the entire contents of which are incorporate herein by reference.

### BACKGROUND

The present technology relates to a secondary battery.

Since various electronic devices such as mobile phones have been widely used, secondary batteries have been developed as power sources that are small and lightweight and can achieve a high energy density. Such a secondary battery includes a positive electrode, a negative electrode, and an electrolytic solution, and various studies have been made on the configuration of the secondary battery.

For example, a secondary battery using a film exterior member includes an electrolytic solution containing a cyclic carbonic acid ester and a chain carboxylic acid ester. Alternatively, a mixed solvent electrolytic solution of a cyclic carbonic acid ester and a propionate ester is used as an electrolytic solution of a secondary battery.

### SUMMARY

The present technology relates to a secondary battery.

Various studies have been made on the configuration of the secondary battery, but the battery characteristics of the secondary battery are still insufficient, and thus there is room for improvement.

A secondary battery is desired that can achieve excellent battery characteristics.

A secondary battery of an embodiment of the present technology includes an exterior member having flexibility, and a positive electrode, a negative electrode, and an electrolytic solution that are housed in the exterior member. The electrolytic solution contains a solvent and an electrolyte salt, and the solvent contains propyl acetate and propyl propionate. The ratio of the content of propyl acetate in the solvent to the sum of the content of propyl acetate in the solvent and the content of propyl propionate in the solvent is 0.1 or more and 0.5 or less.

According to the secondary battery of an embodiment of the present technology, the electrolytic solution is housed in the exterior member having flexibility, the solvent in the electrolytic solution contains propyl acetate and propyl propionate, and the ratio of the content of propyl acetate in the solvent to the sum of the content of propyl acetate in the solvent and the content of propyl propionate in the solvent is 0.1 or more and 0.5 or less, and therefore excellent battery characteristics can be obtained.

An effect of the present technology is not necessarily limited to the effect described here, and may be any of a series of effects relating to the present technology including described below.

### BRIEF DESCRIPTION OF THE FIGURES

FIG. 1 is a perspective view illustrating a configuration of a secondary battery in an embodiment of the present technology.

FIG. 2 is a sectional view illustrating a configuration of the battery element illustrated in FIG. 1.

FIG. 3 is a perspective view illustrating a configuration of a secondary battery in Modification Example 1.

FIG. 4 is a sectional view illustrating a configuration of the battery element illustrated in FIG. 3. FIG. 5 is a plan view illustrating a configuration of the positive electrode illustrated in FIG. 4. FIG. 6 is a plan view illustrating a configuration of the negative electrode illustrated in FIG. 4.

FIG. 7 is a block diagram illustrating a configuration of an application example of a secondary battery.

### DETAILED DESCRIPTION

Hereinafter, an embodiment of the present technology will be described in further detail including with reference to the drawings.

First, a secondary battery of an embodiment of the present technology will be described.

The secondary battery described herein is a secondary battery in which the battery capacity can be obtained by utilizing occlusion and release of an electrode reactant, and includes a positive electrode, a negative electrode, and an electrolytic solution.

The kind of the electrode reactant is not particularly limited, and is specifically a light metal such as an alkali metal or an alkaline earth metal. Specific examples of the alkali metal include lithium, sodium, and potassium. Specific examples of the alkaline earth metal include beryllium, magnesium, and calcium according to an embodiment.

The negative electrode has a larger charge capacity than the positive electrode according to an embodiment. That is, the negative electrode preferably has a larger electrochemical capacity per unit area than the positive electrode. This is for suppressing precipitation of an electrode reactant on the surface of the negative electrode during charging.

Hereinafter, a case where the electrode reactant is lithium will be described as an example. A secondary battery in which the battery capacity can be obtained by utilizing occlusion and release of lithium is a so-called lithium ion secondary battery. In this secondary battery, lithium is occluded and released in an ionic state.

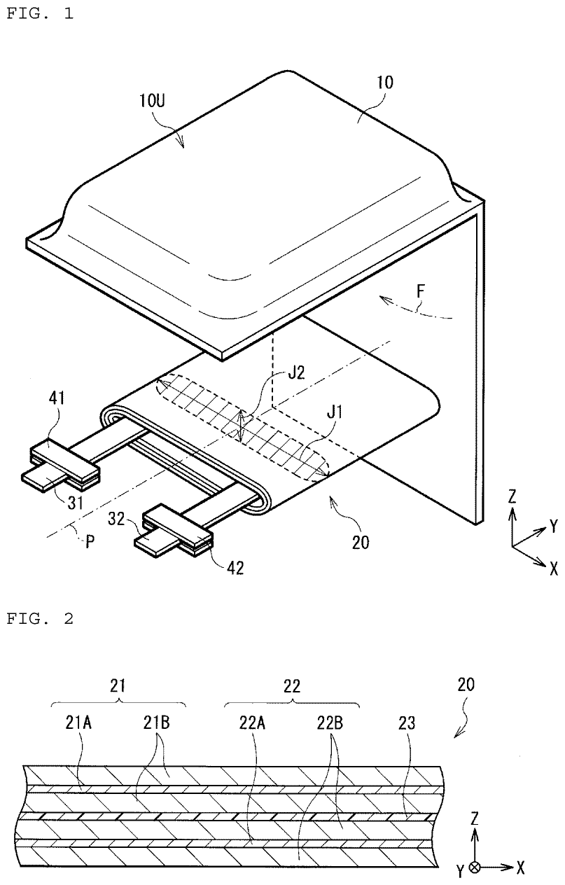

FIG. 1 illustrates a perspective configuration of a secondary battery, and FIG. 2 illustrates a sectional configuration of a battery element 20 illustrated in FIG. 1. However, FIG. 1 illustrates a state where an exterior film 10 and the battery element 20 are separated from each other, and indicates a section of the battery element 20 along the XZ plane with a broken line. FIG. 2 illustrates only a part of the battery element 20.

As illustrated in FIGS. 1 and 2, the secondary battery includes the exterior film 10, the battery element 20, a positive electrode lead 31, a negative electrode lead 32, and sealing films 41 and 42.

As illustrated in FIG. 1, the exterior film 10 is an exterior member having flexibility (or softness), and houses the battery element 20. The exterior film 10 has a bag-shaped structure sealed in a state of housing the battery element 20, and thus houses a positive electrode 21, a negative electrode 22, and an electrolytic solution described below.

The secondary battery using the exterior film 10 as an exterior member having flexibility is a so-called laminate film type secondary battery.

Here, the exterior film 10 is a single film-shaped member, and is folded in a folding direction F. The exterior film 10 is provided with a recess 10U (deep drawn portion) for housing of the battery element 20.

Specifically, the exterior film 10 is a three-layer laminate film in which a fusion layer, a metal layer, and a surface protective layer are stacked in this order from the inside, and in a state where the exterior film 10 is folded, the peripheries of fusion layers facing each other are fused to each other. The fusion layer contains a polymer compound such as polypropylene. The metal layer contains a metal material such as aluminum. The surface protective layer contains a polymer compound such as nylon.

However, the configuration (number of layers) of the exterior film 10 is not particularly limited, and may be one layer, two layers, or four or more layers.

As illustrated in FIGS. 1 and 2, the battery element 20 is a power generating element including a positive electrode 21, a negative electrode 22, a separator 23, and an electrolytic solution (not illustrated), and is housed in the exterior film 10.

The battery element 20 is a so-called wound electrode body. That is, the positive electrode 21 and the negative electrode 22 are wound around a winding axis P while facing each other with the separator 23 interposed therebetween. The winding axis P is an imaginary axis extending in the Y-axis direction.

The three-dimensional shape of the battery element 20 is not particularly limited. Here, the three-dimensional shape of the battery element 20 is flat, and therefore the shape of the section of the battery element 20 intersecting the winding axis P (section along the XZ plane) is a flat shape defined by a major axis J1 and a minor axis J2. The major axis J1 is an imaginary axis extending in the X-axis direction and having a larger length than the minor axis J2. The minor axis J2 is an imaginary axis extending in the Z-axis direction intersecting the X-axis direction and having a smaller length than the major axis J1. Here, the three-dimensional shape of the battery element 20 is a flat cylindrical shape, and therefore the shape of the section of the battery element 20 is a flat substantially elliptical shape.

As illustrated in FIG. 2, the positive electrode 21 includes a positive electrode current collector 21A and a positive electrode active material layer 21B.

The positive electrode current collector 21A has a pair of surfaces on which the positive electrode active material layer 21B is provided. The positive electrode current collector 21A contains a conductive material such as a metal material, and specific examples of the conductive material include aluminum.

The positive electrode active material layer 21B contains any one kind or two or more kinds of positive electrode active materials that occlude and release lithium. However, the positive electrode active material layer 21B may further contain any one kind or two or more kinds of other materials such as a positive electrode binder and a positive electrode conductive agent. A method of forming the positive electrode active material layer 21B is not particularly limited, and is specifically a coating method or the like.

Here, the positive electrode active material layer 21B is provided on both surfaces of the positive electrode current collector 21A. However, the positive electrode active material layer 21B may be provided only on one surface of the positive electrode current collector 21A on the side where the positive electrode 21 faces the negative electrode 22.

The type of the positive electrode active material is not particularly limited, and the positive electrode active material is specifically a lithium-containing compound or the like. This is because a high voltage can be obtained. The lithium-containing compound is a compound containing lithium and one kind or two or more kinds of transition metal elements as constituent elements, and may contain one kind or two or more kinds of other elements (excluding lithium and transition metal elements) as constituent elements. The kinds of other elements are not particularly limited, and the elements are specifically elements belonging to Groups 2 to 15 of the long periodic table. The kind of the lithium-containing compound is not particularly limited, and specific examples of the compound include oxides, phosphoric acid compounds, silicic acid compounds, and boric acid compounds.

Specific examples of the oxides include LiNiO₂, LiCoO₂, LiCo_{0.98}Al_{0.01}Mg_{0.01}O₂, LiNi_{0.5}Co_{0.2}Mn_{0.3}O₂, and LiMn₂O₄. Specific examples of the phosphoric acid compounds include LiFePO₄, LiMnPO₄, and LiFe_{0.5}Mn_{0.5}PO₄.

The positive electrode binder contains any one kind or two or more kinds of materials such as synthetic rubber and a polymer compound. Specific examples of the synthetic rubber include styrene-butadiene rubber, fluorine rubber, and ethylene propylene diene. Specific examples of the polymer compound include polyvinylidene fluoride, polyimides, and carboxymethyl celluloses.

The positive electrode conductive agent contains any one kind or two or more kinds of conductive materials such as a carbon material, a metal material, and a conductive polymer compound, and specific examples of the carbon material include graphite, carbon black, acetylene black, and Ketjen black.

As illustrated in FIG. 2, the negative electrode 22 includes a negative electrode current collector 22A and a negative electrode active material layer 22B.

The negative electrode current collector 22A has a pair of surfaces on which the negative electrode active material layer 22B is provided. The negative electrode current collector 22A contains a conductive material such as a metal material, and specific examples of the conductive material include copper.

The negative electrode active material layer 22B contains any one kind or two or more kinds of negative electrode active materials that occlude and release lithium. However, the negative electrode active material layer 22B may further contain any one kind or two or more kinds of other materials such as a negative electrode binder and a negative electrode conductive agent. A method of forming the negative electrode active material layer 22B is not particularly limited, and is specifically a coating method or the like.

Here, the negative electrode active material layer 22B is provided on both surfaces of the negative electrode current collector 22A. However, the negative electrode active material layer 22B may be provided only on one surface of the negative electrode current collector 22A on the side where the negative electrode 22 faces the positive electrode 21.

The type of the negative electrode active material is not particularly limited, and the negative electrode active material is specifically a carbon material, a metal-based material, or the like. This is because a high energy density can be obtained.

Specific examples of the carbon material include graphitizable carbon, non-graphitizable carbon, and graphite (natural graphite and artificial graphite).

The metal-based material is a material containing any one kind or two or more kinds of metal elements and metalloid elements capable of forming an alloy with lithium as constituent elements, and specific examples of the metal elements and the metalloid elements include silicon and tin. The metal-based material may be a simple substance, an alloy, a compound, a mixture of two or more kinds thereof, or a material including two or more kinds of phases thereof. Specific examples of the metal-based material include TiSi₂ and SiOₓ (0<x≤2 or 0.2<x<1.4).

The details of the negative electrode binder are similar to the details of the positive electrode binder, and the details of the negative electrode conductive agent are similar to the details of the positive electrode conductive agent.

As illustrated in FIG. 2, the separator 23 is an insulating porous film interposed between the positive electrode 21 and the negative electrode 22, and allows lithium ions to pass through the film while preventing short circuit caused by contact between the positive electrode 21 and the negative electrode 22. The separator 23 contains a polymer compound such as polyethylene.

The electrolytic solution is a liquid electrolyte, and the positive electrode 21, the negative electrode 22, and the separator 23 are each impregnated with the electrolytic solution. The electrolytic solution contains a solvent and an electrolyte salt, and the solvent contains a nonaqueous solvent (organic solvent). The electrolytic solution containing the nonaqueous solvent is a so-called nonaqueous electrolytic solution.

Specifically, the solvent contains propyl acetate and propyl propionate, and the mixing ratio of the propyl acetate and the propyl propionate satisfies a predetermined relationship.

Specifically, the content of propyl acetate in the solvent is represented by C1, and the content of propyl propionate in the solvent is represented by C2. In this case, the ratio of the content C1 to the sum of the content C1 and the content C2 is represented by R, and the content ratio R is 0.1 to 0.5. The content ratio R (%) is calculated on the basis of the calculation formula: R=C1/(C1+C2). The value of the content ratio R is a value obtained by rounding off at the third decimal place.

The reason that the content ratio R is set to 0.1 to 0.5 is that as a result of the optimization of the mixing ratio of propyl acetate and propyl propionate, heat generation is suppressed and gas generation is also suppressed during charge and discharge.

Specifically, propyl acetate has a lower viscosity than propyl propionate, and therefore has a property of being less likely to induce heat generation during charge and discharge. However, propyl acetate is easily decomposed during charge and discharge, and therefore has a property of easily generating a gas.

Meanwhile, propyl propionate is less likely to be decomposed during charge and discharge, and therefore has a property of being less likely to generate a gas. However, propyl propionate has a higher viscosity than propyl acetate, and therefore has a property of easily inducing heat generation during charge and discharge.

Thus, propyl acetate and propyl propionate are used in combination and the content ratio R is set to 0.1 to 0.5 according to an embodiment, both the advantage of propyl acetate and the advantage of propyl propionate are achieved, so that heat generation is suppressed and gas generation is also suppressed during charge and discharge. Therefore, when charge and discharge are repeated, the secondary battery is easily operated (discharged) stably, and the secondary battery using the exterior film 10 is less likely to swell according to an embodiment.

The solvent further contains ethylene carbonate, propylene carbonate, and monofluoroethylene carbonate, and the mixing ratio of the ethylene carbonate, the propylene carbonate, and the monofluoroethylene carbonate satisfies a predetermined relationship according to an embodiment.

For example, the content of ethylene carbonate in the solvent is represented by C3, the content of propylene carbonate in the solvent is represented by C4, and the content of monofluoroethylene carbonate in the solvent is represented by C5. In this case, the content C4 is larger than the content C5, and the content C5 is larger than the content C3. That is, the contents C3 to C5 satisfy a relationship of C4>C5>C3 according to an embodiment.

The reason that the contents C3 to C5 are set to satisfy the above-described relationship is that the ion conductivity of the electrolytic solution is improved and gas generation is further suppressed during charge and discharge.

For example, ethylene carbonate has a higher dielectric constant than propylene carbonate, and therefore has a property of easily improving the ion conductivity of the electrolytic solution. However, ethylene carbonate is easily decomposed during charge and discharge, and therefore has a property of easily generating a gas.

Propylene carbonate is less likely to be decomposed during charge and discharge, and therefore has a property of being less likely to generate a gas. However, propylene carbonate has a lower dielectric constant than ethylene carbonate, and therefore has a property of being less likely to improve the ion conductivity of the electrolytic solution.

Furthermore, monofluoroethylene carbonate forms a film on the surface of each of the positive electrode 21 and the negative electrode 22 during charge and discharge to protect the surface of each of the positive electrode 21 and the negative electrode 22. Thus, monofluoroethylene carbonate suppresses a decomposition reaction of the electrolytic solution on the surface of each of the positive electrode 21 and the negative electrode 22, and thus has a property of easily suppressing gas generation. However, monofluoroethylene carbonate is easily decomposed during charge and discharge, and therefore, like ethylene carbonate, has a property of easily generating a gas.

Thus, ethylene carbonate, propylene carbonate, and monofluoroethylene carbonate are used together and the contents C3 to C5 satisfy the above-described relationship according to an embodiment. As a result, the ion conductivity of the electrolytic solution is improved and gas generation is further suppressed during charge and discharge. Therefore, when charge and discharge are repeated, the secondary battery is easily operated further stably, and the secondary battery using the exterior film 10 is further less likely to swell according to an emboidment.

It is preferable that the electrolytic solution further contain succinonitrile and adiponitrile and the mixing ratio of the succinonitrile and the adiponitrile satisfy a predetermined relationship.

For example, the content of succinonitrile in the electrolytic solution is represented by C6, and the content of adiponitrile in the electrolytic solution is represented by C7. In this case, the content C7 is larger than the content C6. That is, the contents C6 and C7 satisfy a relationship of C7>C6.

The reason that the contents C6 and C7 are set to satisfy the above-described relationship is that the oxidation resistance of the electrolytic solution is improved and gas generation is further suppressed during charge and discharge.

Specifically, the electrolytic solution containing propyl acetate and propyl propionate has a property of being easily oxidized during charge and discharge. However, the electrolytic solution further contains succinonitrile and adiponitrile in an embodiment, the electrolytic solution is less likely to be oxidized during charge and discharge.

Here, the electrolytic solution containing propyl acetate and propyl propionate has low polarity, and therefore the electrolytic solution containing succinonitrile and adiponitrile has a problem of the solubility of the succinonitrile and the adiponitrile.

Succinonitrile has a property of easily suppressing gas generation during charge and discharge. However, succinonitrile has a shorter carbon chain than adiponitrile, and therefore the succinonitrile has a property of being less likely to be dissolved. Moreover, succinonitrile also has a property of being capable of increasing the electric resistance.

Meanwhile, adiponitrile has a longer carbon chain than succinonitrile, and therefore the adiponitrile has a property of being easily dissolved. However, although adiponitrile has a property of suppressing gas generation during charge and discharge, the ability of adiponitrile to suppress gas generation is lower than the ability of succinonitrile to suppress gas generation.

Thus, succinonitrile and adiponitrile are used in combination and the contents C6 and C7 satisfy the above-described relationship according to an embodiment. As a result, the oxidation resistance of the electrolytic solution is improved and gas generation is further suppressed while an increase in electric resistance is suppressed during charge and discharge. Therefore, when charge and discharge are repeated, the secondary battery is easily operated further stably, and the secondary battery using the exterior film 10 is further less likely to swell according to an embodiment.

When the contents C1 to C7 are specified, the contents C1 to C7 are measured by disassembling the secondary battery and thus recovering the electrolytic solution, and then analyzing the electrolytic solution. The method of analyzing the electrolytic solution is not particularly limited, and specifically, is any one kind or two or more kinds of high-frequency induction coupled plasma (ICP) emission spectrometry, nuclear magnetic resonance spectroscopy (NMR), gas chromatography-mass spectrometry (GC-MS), and the like.

Here, the solvent may further contain any one kind or two or more kinds of other compounds.

Specifically, other compounds are esters, ethers, and the like, and more specifically, carbonic acid ester-based compounds, carboxylic acid ester-based compounds, and lactone-based compounds, and the like. This is because the dissociation of the electrolyte salt is improved and the mobility of the ions is also improved.

However, the ethylene carbonate and the propylene carbonate described above are excluded from the carbonic acid ester-based compounds described here. The propyl acetate and the propyl propionate described above are excluded from the carboxylic acid ester-based compounds described here.

The carbonic acid ester-based compounds are chain carbonic acid esters, and specific examples of the cyclic carbonic acid esters include dimethyl carbonate, diethyl carbonate, and ethyl methyl carbonate. The carboxylic acid ester-based compounds are chain carboxylic acid esters and the like, and specific examples of the chain carboxylic acid esters include ethyl acetate, ethyl propionate, and ethyl trimethylacetate. The lactone-based compounds are lactones and the like, and specific examples of the lactones include γ-butyrolactone and γ-valerolactone. The ethers may be 1,2-dimethoxyethane, tetrahydrofuran, 1,3-dioxolane, 1,4-dioxane, or the like.

In addition, other compounds are unsaturated cyclic carbonic acid esters, fluorinated cyclic carbonic acid esters, sulfonic acid esters, phosphoric acid esters, acid anhydrides, nitrile compounds, isocyanate compounds, and the like.

However, the above-described monofluoroethylene carbonate is excluded from the fluorinated cyclic carbonic acid esters described here. The succinonitrile and the adiponitrile described above are excluded from the nitrile compounds described here.

Specific examples of the unsaturated cyclic carbonic acid esters include vinylene carbonate, vinyl ethylene carbonate, and methylene ethylene carbonate. Specific examples of the fluorinated cyclic carbonic acid esters include difluoroethylene carbonate. Specific examples of the sulfonic acid esters include propane sultone and propene sultone. Specific examples of the phosphoric acid esters include trimethyl phosphate and triethyl phosphate. Specific examples of the acid anhydrides include succinic anhydride, 1,2-ethanedisulfonic acid anhydride, and 2-sulfobenzoic anhydride. Specific examples of the nitrile compounds include malononitrile. Specific examples of the isocyanate compounds include hexamethylene diisocyanate.

The electrolyte salt contains any one kind or two or more kinds of light metal salts such as a lithium salt. Specific examples of the lithium salt include lithium hexafluorophosphate (LiPF₆), lithium tetrafluoroborate (LiBF₄), lithium trifluoromethanesulfonate (LiCF₃SO₃), lithium bis (fluorosulfonyl) imide (LiN(FSO₂)₂), lithium bis (trifluoromethanesulfonyl) imide (LiN(CF₃SO₂)₂), lithium tris (trifluoromethanesulfonyl) methide (LiC(CF₃SO₂)₃), lithium bis (oxalato) borate (LiB(C₂O₄)₂), lithium monofluorophosphate (Li₂PFO₃), and lithium difluorophosphate (LiPF₂O₂). This is because a high battery capacity can be obtained.

Among them, lithium hexafluorophosphate, which is a phosphate, and lithium bis (fluorosulfonyl) imide, which is an imide salt, are contained together in the electrolyte salt in an embodiment. This is because the ion conductivity of the electrolytic solution is improved and breakage of the positive electrode 21 is suppressed.

Specifically, lithium hexafluorophosphate forms a non-conductive film on the surface of the positive electrode current collector 21A, and thus has a property of suppressing corrosion of the positive electrode current collector 21A. However, lithium hexafluorophosphate has low dissociation ability of lithium ions, and therefore the lithium hexafluorophosphate has a property of decreasing the dielectric constant of the electrolytic solution.

Meanwhile, lithium bis (fluorosulfonyl) imide has high dissociation ability of lithium ions, and therefore the lithium bis (fluorosulfonyl) imide has a property of improving the dielectric constant of the electrolytic solution. However, lithium bis (fluorosulfonyl) imide has a property of corroding the positive electrode current collector 21A at a high voltage. In particular, in a case where the positive electrode current collector 21A contains aluminum, the positive electrode current collector 21A is easily corroded at a high voltage.

Thus, combination use of lithium hexafluorophosphate and lithium bis (fluorosulfonyl) imide improves the ion conductivity of the electrolytic solution and suppresses breakage of the positive electrode 21 during charge and discharge. Therefore, when charge and discharge are repeated, the secondary battery is easily operated further stably.

The content of the electrolyte salt is not particularly limited, and is specifically 0.3 mol/kg to 3.0 mol/kg with respect to the solvent. This is because high ion conductivity can be obtained.

In a case where the electrolyte salt contains lithium hexafluorophosphate and lithium bis (fluorosulfonyl) imide, the mixing ratio of the lithium hexafluorophosphate and the lithium bis (fluorosulfonyl) imide is not particularly limited, and can be arbitrarily set.

As illustrated in FIGS. 1 and 2, the positive electrode lead 31 is a positive electrode terminal connected to the positive electrode current collector 21A of the positive electrode 21, and is led out to the outside of the exterior film 10. The positive electrode lead 31 contains a conductive material such as a metal material, and specific examples of the conductive material include aluminum. The shape of the positive electrode lead 31 is not particularly limited, and is specifically any of a thin plate shape, a mesh shape, and the like.

As illustrated in FIGS. 1 and 2, the negative electrode lead 32 is a negative electrode terminal connected to the negative electrode current collector 22A of the negative electrode 22, and is led out to the outside of the exterior film 10. The negative electrode lead 32 contains a conductive material such as a metal material, and specific examples of the conductive material include copper. Here, the details of the lead-out direction and the shape of the negative electrode lead 32 are similar to the details of the lead-out direction and the shape of the positive electrode lead 31.

The sealing film 41 is inserted between the exterior film 10 and the positive electrode lead 31, and the sealing film 42 is inserted between the exterior film 10 and the negative electrode lead 32. However, one or both of the sealing films 41 and 42 may be omitted.

The sealing film 41 is a sealing member that prevents entry of outside air and the like into the exterior film 10. The sealing film 41 contains a polymer compound such as a polyolefin having an adhesive property to the positive electrode lead 31, and specific examples of the polyolefin include polypropylene.

The configuration of the sealing film 42 is similar to the configuration of the sealing film 41, except that the sealing film 42 is a sealing member having an adhesive property to the negative electrode lead 32. That is, the sealing film 42 contains a polymer compound such as a polyolefin having an adhesive property to the negative electrode lead 32.

The secondary battery operates as described below.

During charge, in the battery element 20, lithium ions are released from the positive electrode 21, and the lithium ions are occluded in the negative electrode 22 via the electrolytic solution. Meanwhile, during discharge, in the battery element 20, lithium ions are released from the negative electrode 22, and the lithium ions are occluded in the positive electrode 21 via the electrolytic solution.

In manufacture of a secondary battery, the positive electrode 21 and the negative electrode 22 are produced according to an exemplary procedure described below, an electrolytic solution is prepared, then a secondary battery is assembled using the positive electrode 21, the negative electrode 22, and the electrolytic solution, and the assembled secondary battery is subjected to stabilization.

First, a positive electrode active material, a positive electrode binder, and a positive electrode conductive agent are mixed together to obtain a positive electrode mixture. Subsequently, the positive electrode mixture is put into a solvent to prepare a paste-like positive electrode mixture slurry. The solvent may be an aqueous solvent or an organic solvent. Finally, the positive electrode mixture slurry is applied onto both surfaces of the positive electrode current collector 21A, and thus the positive electrode active material layer 21B is formed. Thereafter, the positive electrode active material layer 21B may be subjected to compression molding with a roll press or the like. In this case, the positive electrode active material layer 21B may be heated, or may be repeatedly subjected to compression molding a plurality of times. As a result, the positive electrode active material layer 21B is formed on both surfaces of the positive electrode current collector 21A, and thus the positive electrode 21 is produced.

The negative electrode 22 is produced with the procedure similar to the above-described production procedure of the positive electrode 21. Specifically, a negative electrode mixture obtained by mixing a negative electrode active material, a negative electrode binder, and a negative electrode conductive agent together is put into a solvent to prepare a paste-like negative electrode mixture slurry, then the negative electrode mixture slurry is applied onto both surfaces of the negative electrode current collector 22A, and thus the negative electrode active material layer 22B is formed. Thereafter, the negative electrode active material layer 22B may be subjected to compression molding. As a result, the negative electrode active material layer 22B is formed on both surfaces of the negative electrode current collector 22A, and thus the negative electrode 22 is produced.

An electrolyte salt is added to a solvent containing propyl acetate and propyl propionate. As a result, the electrolyte salt is dispersed or dissolved in the solvent, and thus an electrolytic solution is prepared.

In this case, the mixing ratio of propyl acetate and propyl propionate is adjusted so that the content ratio R is 0.1 to 0.5 after completion of the secondary battery (after stabilization described below).

In preparation of an electrolytic solution, as described above, ethylene carbonate, propylene carbonate, and monofluoroethylene carbonate may be added to the solvent so that the contents C3 to C5 satisfy an appropriate relationship.

In preparation of an electrolytic solution, as described above, succinonitrile and adiponitrile may be added to the solvent to which the electrolyte salt is added so that the contents C6 and C7 satisfy an appropriate relationship.

First, the positive electrode lead 31 is connected to the positive electrode current collector 21A of the positive electrode 21 using a joining method such as a welding method, and the negative electrode lead 32 is connected to the negative electrode current collector 22A of the negative electrode 22 using a joining method such as a welding method.

Subsequently, the positive electrode 21 and the negative electrode 22 are stacked with the separator 23 interposed therebetween, and then the positive electrode 21, the negative electrode 22, and the separator 23 are wound to produce a wound body (not illustrated). Subsequently, the wound body is pressed using a press or the like and thus molded into a flat shape. The wound body after the molding has the configuration similar to that of the battery element 20 except that the positive electrode 21, the negative electrode 22, and the separator 23 are not impregnated with the electrolytic solution.

Subsequently, the wound body is housed in the recess 10U, and then the exterior film 10 (fusion layer/metal layer/surface protective layer) is folded to make the exterior films 10 face each other. Subsequently, the peripheries of two sides of the fusion layers facing each other are joined to each other using a bonding method such as a heat fusion method, and thus the wound body is housed in the bag-shaped exterior film 10.

Finally, the electrolytic solution is injected into the bag-shaped exterior film 10, and then the peripheries of the remaining one side of the fusion layers facing each other are joined to each other using a bonding method such as a heat fusion method. In this case, the sealing film 41 is inserted between the exterior film 10 and the positive electrode lead 31, and the sealing film 42 is inserted between the exterior film 10 and the negative electrode lead 32.

As a result, the wound body is impregnated with the electrolytic solution, and thus the battery element 20 that is a wound electrode body is produced. Thus, the battery element 20 is enclosed in the bag-shaped exterior film 10, so that a secondary battery is assembled.

The assembled secondary battery is charged and discharged. Various conditions such as the environmental temperature, the number of times of charge and discharge (the number of cycles), and the charge and discharge conditions can be arbitrarily set. As a result, a film is formed on the surface of the positive electrode 21 and the surface of the negative electrode 22, and thus the state of the battery element 20 is electrochemically stabilized. Thus, a secondary battery is completed.

According to this secondary battery, the electrolytic solution is housed in the exterior film 10, the solvent of the electrolytic solution contains propyl acetate and propyl propionate, and the content ratio R is 0.1 to 0.5.

In this case, as described above, heat generation is suppressed and gas generation is also suppressed during charge and discharge. As a result, when charge and discharge are repeated, the secondary battery is easily operated stably, and the secondary battery using the exterior film 10 is less likely to swell. Therefore, excellent battery characteristics can be obtained.

In particular, the solvent further contains ethylene carbonate, propylene carbonate, and monofluoroethylene carbonate and the contains C3 to C5 satisfy an appropriate relationship (C4>C5>C3) in an embodiment, the ion conductivity of the electrolytic solution is improved and gas generation is further suppressed during charge and discharge. Thus, when charge and discharge are repeated, the secondary battery is easily operated further stably, and the secondary battery using the exterior film 10 is further less likely to swell. Therefore, a higher effect can be obtained.

The electrolytic solution further contains succinonitrile and adiponitrile and the contents C6 and C7satisfy an appropriate relationship (C7>C6) in an embodiment, and the oxidation resistance of the electrolytic solution is improved and gas generation is further suppressed while an increase in electric resistance is suppressed during charge and discharge. Thus, when charge and discharge are repeated, the secondary battery is easily operated further stably, and the secondary battery using the exterior film 10 is further less likely to swell. Therefore, a higher effect can be obtained.

The electrolyte salt contains lithium hexafluorophosphate and lithium bis (fluorosulfonyl) imide according to an embodiment, and the ion conductivity of the electrolytic solution is improved and breakage of the positive electrode 21 is suppressed during charge and discharge. Therefore, when charge and discharge are repeated, the secondary battery is easily operated further stably, and therefore a higher effect can be obtained.

The secondary battery is a lithium ion secondary battery, and a sufficient battery capacity can be stably obtained by utilizing occlusion and release of lithium, so that a higher effect can be obtained.

The configuration of the secondary battery can be appropriately changed as described below according to an embodiment. A series of modification examples described below may be combined with each other.

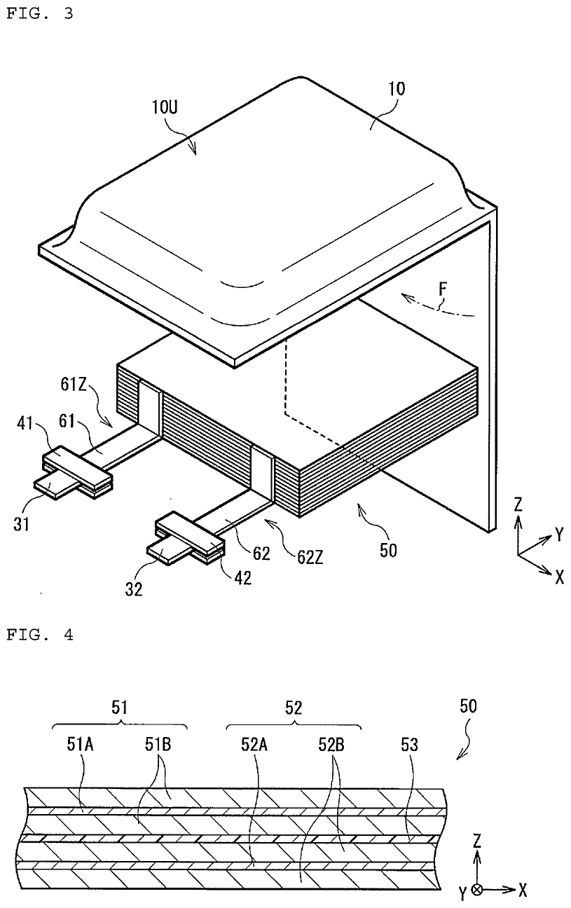

In FIGS. 1 and 2, the secondary battery includes the battery element 20 that is a wound electrode body. However, as illustrated in FIGS. 3 to 6, a secondary battery may include a battery element 50 that is a laminated electrode body instead of the battery element 20 that is a wound electrode body.

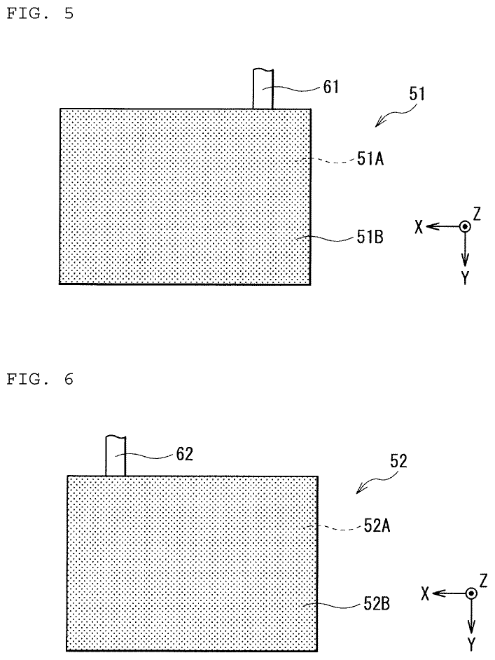

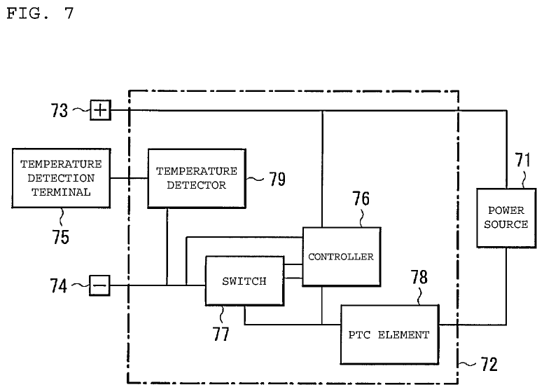

FIG. 3 illustrates a perspective configuration of the secondary battery in Modification Example 1, and corresponds to FIG. 1. FIG. 4 illustrates a sectional configuration of the battery element 50 illustrated in FIG. 3, and corresponds to FIG. 2. FIG. 5 illustrates a planar configuration of a positive electrode 51 illustrated in FIG. 4, and FIG. 6 illustrates a planar configuration of a negative electrode 52 illustrated in FIG. 4. However, FIG. 4 illustrates only a part of the battery element 50.

The configuration of the secondary battery in Modification Example 1 (FIGS. 3 to 6) is similar to the configuration of the above-described secondary battery (FIGS. 1 and 2) except for the following description.

As illustrated in FIGS. 3 to 6, the secondary battery includes an exterior film 10, the battery element 50, a plurality of positive electrode terminals 61, a plurality of negative electrode terminals 62, a positive electrode lead 31, a negative electrode lead 32, and sealing films 41 and 42.

As illustrated in FIGS. 3 and 4, the battery element 50 includes the positive electrode 51, the negative electrode 52, a separator 53, and an electrolytic solution (not illustrated), and is a laminated electrode body as described above. That is, the positive electrode 51 and the negative electrode 52 are alternately stacked with the separator 53 interposed therebetween. The numbers of positive electrodes 51, negative electrodes 52, and separators 53 are not particularly limited, and can be arbitrarily set.

The positive electrode 51 includes a positive electrode current collector 51A and a positive electrode active material layer 51B. The configuration of the positive electrode current collector 51A is similar to the configuration of the positive electrode current collector 21A, and the configuration of the positive electrode active material layer 51B is similar to the configuration of the positive electrode active material layer 21B.

Here, as illustrated in FIG. 5, a part of the positive electrode current collector 51A protrudes, and thus the positive electrode current collector 51A includes a portion protruding outward from the positive electrode active material layer 51B (hereinafter, referred to as “protrusion of the positive electrode current collector 51A”). The protrusion of the positive electrode current collector 51A is not provided with the positive electrode active material layer 51B, and thus the protrusion of the positive electrode current collector 51A functions as the positive electrode terminal 61. The details of the positive electrode terminal 61 will be described below.

The negative electrode 52 includes a negative electrode current collector 52A and a negative electrode active material layer 52B. The configuration of the negative electrode current collector 52A is similar to the configuration of the negative electrode current collector 22A, and the configuration of the negative electrode active material layer 52B is similar to the configuration of the negative electrode active material layer 22B.

Here, as illustrated in FIG. 6, a part of the negative electrode current collector 52A protrudes, and thus the negative electrode current collector 52A includes a portion protruding outward from the negative electrode active material layer 52B (hereinafter, referred to as “protrusion of the negative electrode current collector 52A”). The protrusion of the negative electrode current collector 52A is not provided with the negative electrode active material layer 52B, and thus the protrusion of the negative electrode current collector 52A functions as the negative electrode terminal 62. The details of the negative electrode terminal 62 will be described below.

The configuration of the separator 53 is similar to the configuration of the separator 23. The configuration of the electrolytic solution is as described above.

As illustrated in FIG. 5, the positive electrode terminal 61 is electrically connected to the positive electrode 51, and more specifically, is electrically connected to the positive electrode current collector 51A. In the battery element 50, as described above, the positive electrode 51 and the negative electrode 52 are alternately stacked with the separator 53 interposed therebetween, and thus the battery element 50 includes a plurality of positive electrodes 51. Thus, the secondary battery includes the plurality of positive electrode terminals 61.

A material for formation of the positive electrode terminal 61 is not particularly limited, and is specifically similar to the material for formation of the positive electrode current collector 51A.

Here, as described above, the protrusion of the positive electrode current collector 51A functions as the positive electrode terminal 61, and thus the positive electrode terminal 61 is physically integrated with the positive electrode current collector 51A. This is because a decrease in the connection resistance between the positive electrode current collector 51A and the positive electrode terminal 61 causes a decrease in the electric resistance of the entire secondary battery.

The plurality of positive electrode terminals 61 are joined to each other, and thus form one lead-shaped joining portion 61Z.

As illustrated in FIG. 6, the negative electrode terminal 62 is electrically connected to the negative electrode 52, and more specifically, is electrically connected to the negative electrode current collector 52A. In the battery element 50, as described above, the positive electrode 51 and the negative electrode 52 are alternately stacked with the separator 53 interposed therebetween, and thus the battery element 50 includes a plurality of negative electrodes 52. Thus, the secondary battery includes the plurality of negative electrode terminals 62. A material for formation of the negative electrode terminal 62 is not particularly limited, and is specifically similar to the material for formation of the negative electrode current collector 52A.

In a state where the positive electrode 51 and the negative electrode 52 are alternately stacked with the separator 53 interposed therebetween, the negative electrode terminal 62 is disposed at a position not overlapping with the positive electrode terminal 61.

Here, as described above, the protrusion of the negative electrode current collector 52A functions as the negative electrode terminal 62, and thus the negative electrode terminal 62 is physically integrated with the negative electrode current collector 52A. This is because a decrease in the connection resistance between the negative electrode current collector 52A and the negative electrode terminal 62 causes a decrease in the electric resistance of the entire secondary battery.

The plurality of negative electrode terminals 62 are joined to each other, and thus form one lead-shaped joining portion 62Z.

The method of manufacturing a secondary battery in Modification Example 1 (FIGS. 3 to 6) is similar to the above-described method of manufacturing a secondary battery (FIGS. 1 and 2) except for the following description.

The procedure of producing the positive electrode 51 is substantially similar to the procedure of producing the positive electrode 21. In this case, a positive electrode mixture slurry is applied onto both surfaces (excluding the positive electrode terminal 61) of the positive electrode current collector 51A with which the positive electrode terminal 61 is integrated, and thus the positive electrode active material layer 51B is formed.

The procedure of producing the negative electrode 52 is substantially similar to the procedure of producing the negative electrode 22. In this case, a negative electrode mixture slurry is applied onto both surfaces (excluding the negative electrode terminal 62) of the negative electrode current collector 52A with which the negative electrode terminal 62 is integrated, and thus the negative electrode active material layer 52B is formed.

In assembly of the secondary battery, first, the positive electrode 51 and the negative electrode 52 are alternately stacked with the separator 53 interposed therebetween to produce a laminate (not illustrated). This laminate has a configuration similar to the configuration of the battery element 50 except that the positive electrode 51, the negative electrode 52, and the separator 53 are each not impregnated with the electrolytic solution and the joining portions 61Z, 62Z are not yet formed.

Subsequently, the plurality of positive electrode terminals 61 are joined to each other using a joining method such as a welding method to form the joining portion 61Z, and then the positive electrode lead 31 is connected to the joining portion 61Z using a similar joining method. Furthermore, the plurality of negative electrode terminals 62 are joined to each other using a joining method such as a welding method to form the joining portion 62Z, and then the negative electrode lead 32 is connected to the joining portion 62Z using a similar joining method.

Also in the case of using the battery element 50 that is a laminated electrode body, a battery capacity can be obtained by utilizing occlusion and release of lithium, so that a similar effect can be obtained.

A separator 23 that was a porous film was used. However, a laminated separator including a polymer compound layer may be used although not specifically illustrated in the drawings.

Specifically, the laminated separator includes a porous film having a pair of surfaces and a polymer compound layer provided on one surface or both surfaces of the porous film. This is because the adhesive property of the separator to a positive electrode 21 and a negative electrode 22 is improved to suppress winding deviation of a battery element 20. Thus, when a decomposition reaction of an electrolytic solution occurs, swelling of a secondary battery is suppressed. The polymer compound layer contains a polymer compound such as polyvinylidene fluoride. Polyvinylidene fluoride is excellent in physical strength, and electrochemically stable.

One or both of the porous film and the polymer compound layer may contain a plurality of insulating particles. This is because the plurality of insulating particles promote heat dissipation at the time of heat generation of the secondary battery to improve the safety (heat resistance) of the secondary battery. The plurality of insulating particles contain any one kind or two or more kinds of insulating materials such as inorganic materials and resin materials. Specific examples of the inorganic materials include aluminum oxide, aluminum nitride, boehmite, silicon oxide, titanium oxide, magnesium oxide, and zirconium oxide. Specific examples of the resin materials include an acrylic resin and a styrene resin.

When a laminated separator is produced, a precursor solution containing a polymer compound, a solvent, and the like is prepared, and then the precursor solution is applied onto one surface or both surfaces of the porous film. In this case, a plurality of insulating particles may be added to the precursor solution as necessary.

Also in the case of using the laminated separator, lithium ions can move between the positive electrode 21 and the negative electrode 22, so that a similar effect can be obtained. In this case, in particular, as described above, the safety of the secondary battery is improved, and therefore a higher effect can be obtained.

An electrolytic solution that was a liquid electrolyte was used. However, an electrolyte layer that is a gel-like electrolyte may be used, although not specifically illustrated in the drawings.

In a battery element 20 using the electrolyte layer, a positive electrode 21 and a negative electrode 22 are alternately stacked with a separator 23 and the electrolyte layer interposed therebetween, and the positive electrode 21, the negative electrode 22, the separator 23, and the electrolyte layer are wound. The electrolyte layer is interposed between the positive electrode 21 and the separator 23, and is interposed between the negative electrode 22 and the separator 23.

Specifically, the electrolyte layer contains the electrolytic solution and a polymer compound, and the electrolytic solution is held by the polymer compound. This is because leakage of the electrolytic solution is prevented. The configuration of the electrolytic solution is as described above. The polymer compound contains polyvinylidene fluoride or the like. When the electrolyte layer is formed, a precursor solution containing the electrolytic solution, the polymer compound, a solvent, and the like is prepared, then the precursor solution is applied onto one surface or both surfaces of the positive electrode 21, and the precursor solution is applied onto one surface or both surfaces of the negative electrode 22.

Also in the case of using the electrolyte layer, lithium ions can move between the positive electrode 21 and the negative electrode 22 via the electrolyte layer, so that a similar effect can be obtained. In this case, in particular, as described above, leakage of the electrolytic solution is prevented, so that a higher effect can be obtained.

The application (application example) of the secondary battery is not particularly limited. The secondary battery to be used as a power source may be a main power source or an auxiliary power source in electronic devices, electric vehicles, and the like. The main power source is a power source that is preferentially used regardless of the presence or absence of another power source. The auxiliary power source may be a power source that is used in place of the main power source, or a power source with which the main power source can be switched.

Specific examples of the application of the secondary battery are as described below: electronic devices such as video camcorders, digital still cameras, mobile phones, notebook personal computers, headphone stereos, portable radios, and portable information terminals; storage devices such as backup power sources and memory cards; power tools such as electric drills and electric saws; battery packs mounted on electronic devices and the like; medical electronic devices such as pacemakers and hearing aids; electric vehicles such as electric automobiles (including hybrid automobiles); and electric power storage systems such as home or industrial battery systems that store electric power in preparation for emergency. In these applications, one secondary battery may be used, or a plurality of secondary batteries may be used.

In the battery packs, a single battery or an assembled battery may be used. The electric vehicles are a vehicle that travels using a secondary battery as a power source for driving, and may be a hybrid automobile including a driving source other than the secondary battery. In the home electric power storage systems, home electric products and the like can be used by utilizing electric power stored in a secondary battery as an electric power storage source.

Here, one of the application examples of the secondary battery will be specifically described. The configuration of an application example described below is merely an example, and can be changed as appropriate.

FIG. 7 illustrates a block configuration of a battery pack. The battery pack described herein is a battery pack including one secondary battery (so-called soft pack), and is mounted on an electronic device typified by a smartphone.

The battery pack includes a power source 71 and a circuit board 72, as illustrated in FIG. 7. The circuit board 72 is connected to the power source 71, and includes a positive electrode terminal 73, a negative electrode terminal 74, and a temperature detection terminal 75.

The power source 71 includes one secondary battery. In the secondary battery, a positive electrode lead is connected to the positive electrode terminal 73, and a negative electrode lead is connected to the negative electrode terminal 74. The power source 71 can be connected to the outside via the positive electrode terminal 73 and the negative electrode terminal 74, and thus can be charged and discharged. The circuit board 72 includes a controller 76, a switch 77, a positive temperature coefficient element 78, and a temperature detector 79. Specific examples of the positive temperature coefficient element 78 include a PTC element, and the positive temperature coefficient element 78 may be omitted.

The controller 76 includes a central processing unit (CPU), a memory, and the like, and controls the operation of the entire battery pack. The controller 76 detects and controls the state of using the power source 71 as necessary.

When the voltage of the power source 71 (secondary battery) reaches an overcharge detection voltage or an overdischarge detection voltage, the controller 76 disconnects the switch 77 to prevent a charge current from flowing through a current path of the power source 71. The overcharge detection voltage is not particularly limited and is specifically 4.20 V+0.05 V, and the overdischarge detection voltage is not particularly limited and is specifically 2.40 V+0.1 V.

The switch 77 includes a charge control switch, a discharge control switch, a charge diode, a discharge diode, and the like, and switches connection or disconnection between the power source 71 and an external device according to an instruction of the controller 76. The switch 77 includes a field effect transistor using a metal oxide semiconductor (MOSFET), and the like, and a charge current and a discharge current are each detected on the basis of the on-resistance of the switch 77.

The temperature detector 79 includes a temperature detecting element such as a thermistor. The temperature detector 79 measures the temperature of the power source 71 using the temperature detection terminal 75, and outputs the result of measuring the temperature to the controller 76. The result of measuring the temperature measured by the temperature detector 79 is used, for example, in charge and discharge control by the controller 76 at the time of abnormal heat generation, and in correction processing by the controller 76 at the time of calculation of the remaining capacity.

### EXAMPLES

Examples of the present technology will be described according to an embodiment.

### Examples 1 to 3 and Comparative Examples 1 and 2

As described below, a secondary battery was produced, and then battery characteristics of the secondary battery were evaluated.

### [Production of Secondary Battery]

The secondary battery illustrated in FIGS. 1 and 2 was produced with the procedure described below. The secondary battery is a laminate film type lithium ion secondary battery as described above.

### (Production of Positive Electrode)

First, 91 parts by mass of a positive electrode active material (LiCoO₂ as a lithium-containing compound (oxide)), 3 parts by mass of a positive electrode binder (polyvinylidene fluoride), and 6 parts by mass of a positive electrode conductive agent (Ketjen black as an amorphous carbon powder) were mixed together to obtain a positive electrode mixture. Subsequently, the positive electrode mixture was put into a solvent (N-methyl-2-pyrrolidone as an organic solvent), and then the solvent was stirred to prepare a paste-like positive electrode mixture slurry.

Subsequently, the positive electrode mixture slurry was applied onto both surfaces of a positive electrode current collector 21A (aluminum foil having a thickness of 10 μm) using a coating apparatus, and then the positive electrode mixture slurry was dried to form a positive electrode active material layer 21B.

Finally, the positive electrode active material layer 21B was subjected to compression molding with a roll press, and then the positive electrode current collector 21A on which the positive electrode active material layer 21B was formed was cut into a strip. Thus, a positive electrode 21 was produced.

### (Production of Negative Electrode)

First, 93 parts by mass of a negative electrode active material (artificial graphite as a carbon material) and 7 parts by mass of a negative electrode binder (polyvinylidene fluoride) were mixed together to obtain a negative electrode mixture. Subsequently, the negative electrode mixture was put into a solvent (N-methyl-2-pyrrolidone as an organic solvent), and then the solvent was stirred to prepare a paste-like negative electrode mixture slurry.

Subsequently, the negative electrode mixture slurry was applied onto both surfaces of a negative electrode current collector 22A (copper foil having a thickness of 8 μm) using a coating apparatus, and then the negative electrode mixture slurry was dried to form a negative electrode active material layer 22B.

Finally, the negative electrode active material layer 22B was subjected to compression molding with a roll press, and then the negative electrode current collector 22A on which the negative electrode active material layer 22B was formed was cut into a strip. Thus, a negative electrode 22 was produced.

### (Preparation of Electrolytic Solution)

First, a solvent was prepared. As the solvent, a mixture of propyl acetate (PrAc), propyl propionate (PrPr), ethylene carbonate (EC), propylene carbonate (PC), and monofluoroethylene carbonate (FEC) was used. In this case, as described below, the mixing ratio (weight ratio) of the solvent was adjusted so that the contents C1 to C5 (wt %) and the content ratio R (%) were the values shown in Table 1 when the electrolytic solution was analyzed after completion of the secondary battery.

Subsequently, an electrolyte salt was added to the solvent, and then the solvent was stirred. As the electrolyte salt, a mixture of lithium hexafluorophosphate (LiPF₆) and lithium bis (fluorosulfonyl) imide (LIN(FSO₂)₂) was used. In this case, the content of lithium hexafluorophosphate was 0.5 mol/kg with respect to the solvent, and the content of lithium bis (fluorosulfonyl) imide was 0.5 mol/kg with respect to the solvent. Thus, an electrolytic solution was prepared.

Finally, succinonitrile (SN) and adiponitrile (ADN) were added to the electrolytic solution, and then the electrolytic solution was stirred. In this case, as described below, the amounts of the added succinonitrile and the added adiponitrile were adjusted so that the contents C6 and C7 (wt %) were the values shown in Table 1 when the electrolytic solution was analyzed after completion of the secondary battery.

### (Assembly of Secondary Battery)

First, a positive electrode lead 31 (aluminum foil) was welded to the positive electrode current collector 21A of the positive electrode 21, and a negative electrode lead 32 (copper foil) was welded to the negative electrode current collector 22A of the negative electrode 22.

Subsequently, the positive electrode 21 and the negative electrode 22 were stacked with a separator 23 (microporous polyethylene film having a thickness of 25 μm) interposed therebetween, and then the positive electrode 21, the negative electrode 22, and the separator 23 were wound to produce a wound body. Subsequently, the wound body was pressed using a press and thus molded into a flat shape.

Subsequently, an exterior film 10 was folded so as to sandwich the wound body housed in a recess 10U. As the exterior film 10, an aluminum laminate film was used in which a fusion layer (polypropylene film having a thickness of 30 μm), a metal layer (aluminum foil having a thickness of 40 μm), and a surface protective layer (nylon film having a thickness of 25 μm) were stacked in this order from the inside. Subsequently, the peripheries of two sides of the fusion layers facing each other were heat-fused to each other, and thus the wound body was housed in the bag-shaped exterior film 10.

Finally, the electrolytic solution was injected into the bag-shaped exterior film 10, and then in a reduced-pressure environment, the peripheries of the remaining one side of the fusion layers facing each other were heat-fused to each other. In this case, a sealing film 41 (polypropylene film having a thickness of 5 μm) was inserted between the exterior film 10 and the positive electrode lead 31, and a sealing film 42 (polypropylene film having a thickness of 5 μm) was inserted between the exterior film 10 and the negative electrode lead 32.

Thus, the wound body was impregnated with the electrolytic solution, so that a battery element 20 was produced. Thus, the battery element 20 was enclosed in the exterior film 10, so that a secondary battery was assembled.

### (Stabilization of Secondary Battery)

The assembled secondary battery was charged and discharged for one cycle in a normal temperature environment (temperature=23° C.). At the time of charge, constant current charge was performed at a current of 0.1 C until the voltage reached 4.2 V, and then constant voltage charge was performed at a voltage of 4.2 V until the current reached 0.025 C. At the time of discharge, constant current discharge was performed at a current of 0.1 C until the voltage reached 3.0 V. Note that 0.1 C is a current value at which the battery capacity (theoretical capacity) can be discharged in 10 hours, and 0.025 C is a current value at which the battery capacity can be discharged in 40 hours.

As a result, the state of the battery element 20 was electrochemically stabilized, and thus the secondary battery was completed.

After completion of the secondary battery, the electrolytic solution was analyzed using ICP emission spectrometry and Table 1 shows the results. Table 1 shows the content C1 (wt %) of propyl acetate (PrAc) in the solvent, the content C2 (wt %) of propyl propionate (PrPr) in the solvent, the content C3 (wt %) of ethylene carbonate (EC) in the solvent, the content C4 (wt %) of propylene carbonate (PC) in the solvent, the content C5 (wt %) of monofluoroethylene carbonate (FEC) in the solvent, the content C6 (wt %) of succinonitrile (SN) in the electrolytic solution, the content C7 (wt %) of adiponitrile (ADN) in the electrolytic solution, and the content ratio R (%).

### [Evaluation of Battery Characteristics]

As the battery characteristics, the discharge characteristics and the swelling characteristics were evaluated with the procedure described below, and the results shown in Table 1 were obtained.

### (Discharge Characteristics)

First, a temperature measurement sensor connected to a temperature measurement logger was attached to the secondary battery using Kapton (registered trademark) tape. In this case, the temperature measurement sensor was disposed substantially at the center of the upper surface (substantially flat surface) of the exterior film 10.

Subsequently, in a thermostatic bath (temperature=25° C.+1° C.), the secondary battery was charged and discharged while the temperature of the secondary battery was measured every 1 second using the temperature measurement logger. At the time of charge, constant current charge was performed at a current of 0.5 C until the voltage reached 4.2 V, and then constant voltage charge was performed at a voltage of 4.2 V until the current reached 0.03 C. At the time of discharge, constant current discharge was performed at a current of 10 C until the voltage reached 2.5 V. Note that 0.5 C is a current value at which the battery capacity can be discharged in 2 hours, 10 C is a current value at which the battery capacity can be discharged in 0.1 hours, and 0.03 C is a current value at which the battery capacity can be discharged in 100/3hours.

Finally, after completion of the charge and discharge, the maximum value of the temperature measured using the temperature measurement logger was examined to specify the maximum temperature (° C.) as an index for evaluation of the discharge characteristics.

At the time of discharge at a large current, the battery element 20 generates heat to increase the temperature of the secondary battery. In this case, at the time of temperature rise, it is necessary to stop charge and discharge using a protection circuit in order to ensure the safety. Thus, the maximum temperature is a temperature reflecting the time from the start of charge and discharge to the stop of charge and discharge (discharge time), and therefore becomes an index for evaluation of the discharge characteristics.

As the maximum temperature is lower, the time until charge and discharge are stopped (the time during which discharge is possible) is longer, so that the secondary battery can be stably used for a long period of time. Meanwhile, as the maximum temperature is higher, the time until charge and discharge are stopped is shorter, so that the secondary battery is difficult to use stably for a long period of time.

### (Swelling Characteristics)

First, the secondary battery was charged in a normal temperature environment (temperature=23°° C.), and then the thickness (thickness before storage) of the secondary battery was measured. In this case, constant current charge was performed at a current of 0.1 C until the voltage reached 4.2 V, and then constant voltage charge was performed at a voltage of 4.2 V until the current reached 0.025 C. The thickness of the secondary battery is a dimension from the upper surface (substantially flat surface) of the exterior film 10 to the lower surface (substantially flat surface on the opposite side) of the exterior film 10.

Subsequently, the secondary battery in a charged state was stored in a high temperature environment (temperature=60° C.) (storage period=2 months), and then the thickness (thickness after storage) of the secondary battery was measured.

Finally, the swelling rate, which is an index for evaluation of the swelling characteristics, was calculated on the basis of the calculation formula: swelling rate (%)=[(thickness after storage-thickness before storage)/thickness before storage]×100.

TABLE 1
Content C3 = 10 wt %, content C4 = 16.2 wt %, content C5 = 12.5 wt %
Content C6 = 0.7 wt %, content C7 = 1 wt %

| | Solvent | | | | | |
|---|---|---|---|---|---|---|
| | PrAc | PrPr | Content | | Maximum | |
| | Content C1 | Content C2 | ratio | Electrolyte | temperature | Swelling |
| | (wt %) | (wt %) | R | salt | (° C.) | rate (%) |
| Comparative | 1.3 | 60 | 0.02 | LiPF₆ + | 77 | 1 |
| Example 1 | | | | LiN | | |
| Example 1 | 6.3 | 55 | 0.1 | (FSO₂) ₂ | 75 | 2 |
| Example 2 | 21.3 | 40 | 0.35 | | 72 | 2 |
| Example 3 | 30.6 | 30.7 | 0.5 | | 70 | 2 |
| Comparative | 40 | 21.3 | 0.65 | | 70 | 10 |
| Example 2 | | | | | | |

As shown in Table 1, the maximum temperature and the swelling rate greatly varied according to the configuration of the electrolytic solution.

Specifically, in the case of a content ratio R of less than 0.1 (Comparative Example 1), the swelling rate was decreased, but the maximum temperature was increased. In the case of a content ratio R of more than 0.5 (Comparative Example 2), the maximum temperature was decreased, but the swelling rate was increased.

Meanwhile, in the case of a content ratio R of 0.1 to 0.5 (Examples 1 to 3), the maximum temperature was decreased, and the swelling rate was decreased. In this case, particularly in the case of an electrolyte salt containing lithium hexafluorophosphate and lithium bis (fluorosulfonyl) imide, the maximum temperature was sufficiently decreased, and the swelling rate was sufficiently decreased.

### Examples 4 to 6

A secondary battery was produced with a procedure similar to that in Example 1 except that the contents C3 to C5 (wt %) were changed and the cycle characteristics were evaluated instead of the discharge characteristics as shown in Table 2, and the battery characteristics were evaluated.

The column of “Appropriate relationship” in Table 2 indicates whether the contents C3 to C5 satisfy an appropriate relationship (C4>C5>C3). That is, “Satisfied” indicates that an appropriate relationship is satisfied, and “Unsatisfied” indicates that an appropriate relationship is unsatisfied.

In the case of evaluating the cycle characteristics, first, the secondary battery was charged and discharged in a normal temperature environment (temperature=23° C.), and thus the discharge capacity (discharge capacity at the first cycle) was measured. Subsequently, the secondary battery was repeatedly charged and discharged in the same environment until the total number of cycles reached 100, and thus the discharge capacity (discharge capacity at the 100th cycle) was measured. Finally, the capacity retention rate, which is an index for evaluation of the cycle characteristics, was calculated on the basis of the calculation formula: capacity retention rate (%)=(discharge capacity at the 100th cycle/discharge capacity at the first cycle)×100. The charge and discharge conditions were similar to those at the time of stabilization.

TABLE 2
Content ratio R = 0.1

| | Solvent | | | | | | |
|---|---|---|---|---|---|---|---|
| | EC | PC | FEC | | | Capacity | |
| | Content | Content | Content | Appropriate | | retention | Swelling |
| | C3 | C4 | C5 | relationship | Electrolyte | rate | rate |
| | (wt %) | (wt %) | (wt %) | (C4 > C5 > C3) | salt | (%) | (%) |
| Example | 10 | 16.2 | 12.5 | Satisfied | LiPF₆ + LiN | 83 | 2 |
| 1 | | | | | (FSO₂) ₂ | | |
| Example | 7.5 | 16.2 | 15 | Satisfied | | 81 | 3 |
| 4 | | | | | | | |
| Example | 10 | 18.7 | 10 | Unsatisfied | | 78 | 3 |
| 5 | | | | | | | |
| Example | 13.7 | 16.2 | 8.8 | Unsatisfied | | 75 | 5 |
| 6 | | | | | | | |

As shown in Table 2, in a case where the contents C3 to C5 satisfied an appropriate relationship (Examples 1 and 4), the capacity retention rate was larger while the swelling rate was suppressed than in a case where the contents C3 to C5 did not satisfy an appropriate relationship (Examples 5 and 6).

### Examples 7 to 9

A secondary battery was produced with a procedure similar to that in Example 1 except that the contents C6 and C7 (wt %) were changed as shown in Table 3, and the battery characteristics were evaluated.

The column of “Appropriate relationship” in Table 3 indicates whether the contents C6 and C7 satisfy an appropriate relationship (C7>C6). That is, “Satisfied” indicates that an appropriate relationship is satisfied, and “Unsatisfied” indicates that an appropriate relationship is unsatisfied.

TABLE 3
Content ratio R = 0.1

| | Additive | | | | | |
|---|---|---|---|---|---|---|
| | SN | ADN | | | | |
| | Content | Content | Appropriate | | Maximum | |
| | C6 | C7 | relationship | Electrolyte | temperature | Swelling |
| | (wt %) | (wt %) | (C7 > C6) | salt | (° C.) | rate (%) |
| Example 1 | 0.7 | 1 | Satisfied | LiPF₆ + LiN (FSO₂) ₂ | 75 | 2 |
| Example 7 | — | — | — | | 75 | 20 |
| Example 8 | 0.85 | 0.85 | Unsatisfied | | 77 | 2 |
| Example 9 | 1 | 0.7 | Unsatisfied | | 79 | 3 |

As shown in Table 3, in a case where the electrolytic solution contained succinonitrile and adiponitrile and the contents C6 and C7 satisfied an appropriate relationship (Example 1), the maximum temperature was sufficiently suppressed and the swelling rate was also sufficiently suppressed as compared with a case where the electrolytic solution did not contain succinonitrile and adiponitrile (Example 7) and a case where the electrolytic solution contained succinonitrile and adiponitrile but the contents C6 and C7 did not satisfy an appropriate relationship (Examples 8 and 9).

### SUMMARY

From the results shown in Tables 1 to 3, the secondary battery obtained excellent battery characteristics when the electrolytic solution was housed in the exterior film 10, the solvent of the electrolytic solution contained propyl acetate and propyl propionate, and the content ratio R was 0.1 to 0.5.

The present technology is described above with reference to an embodiment and Examples, but the configuration of the present technology is not limited to the configurations described in the embodiment and Examples, and can be variously modified.

Specifically, a case is described above in which the battery structure of the secondary battery is a laminate film type. However, the battery structure of the secondary battery is not particularly limited, and therefore may be a cylindrical type, a square type, a coin type, a button type, or the like.

In addition, a case is described above in which the element structure of the battery element is a wound type. However, the element structure of the battery element is not particularly limited, and therefore may be a laminated type, a zigzag-folded type, or the like. In the laminated type, a positive electrode and a negative electrode are alternately stacked with a separator interposed therebetween, and in the zigzag-folded type, a positive electrode and a negative electrode are folded in a zigzag manner while facing each other with a separator interposed therebetween.

Furthermore, a case is described above in which the electrode reactant is lithium, but the kind of the electrode reactant is not particularly limited. Specifically, as described above, the electrode reactant may be another alkali metal such as sodium or potassium, or an alkaline earth metal such as beryllium, magnesium, or calcium. The electrode reactant may be another light metal such as aluminum.

An effect described in the present description is merely an example, and therefore an effect of the present technology is not limited to an effect described in the present description. Therefore, another effect regarding the present technology may be obtained.

The present technology can also take the following configurations according to an embodiment.

<1> A secondary battery including:
an exterior member having flexibility;
a positive electrode;
a negative electrode; and
an electrolytic solution,
the positive electrode, the negative electrode, and the electrolytic solution that are housed in the exterior member,
the electrolytic solution containing a solvent and an electrolyte salt,
the solvent containing propyl acetate and propyl propionate, wherein
a ratio of a content of the propyl acetate in the solvent to a sum of the content of the propyl acetate in the solvent and a content of the propyl propionate in the solvent is 0.1 or more and 0.5 or less.

<2> The secondary battery according to <1>, wherein
the solvent further contains ethylene carbonate,
propylene carbonate, and monofluoroethylene carbonate,
a content of the propylene carbonate in the solvent is larger than a content of the monofluoroethylene carbonate in the solvent, and
a content of the monofluoroethylene carbonate in the solvent is larger than a content of the ethylene carbonate in the solvent.

<3> The secondary battery according to <1>or <2>, wherein
the electrolytic solution further contains succinonitrile and adiponitrile, and
a content of the adiponitrile in the electrolytic solution is larger than a content of the succinonitrile in the electrolytic solution.

<4> The secondary battery according to any one of <1>to <3>, wherein the electrolyte salt contains lithium hexafluorophosphate and lithium bis (fluorosulfonyl) imide.

<5> The secondary battery according to any one of <1>to <4>, being a lithium ion secondary battery.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an exterior member having flexibility;
a positive electrode;
a negative electrode; and
an electrolytic solution,
the positive electrode, the negative electrode, and the electrolytic solution that are housed in the exterior member,
the electrolytic solution including a solvent and an electrolyte salt,
the solvent including propyl acetate and propyl propionate, wherein
a ratio of a content of the propyl acetate in the solvent to a sum of the content of the propyl acetate in the solvent and a content of the propyl propionate in the solvent is 0.1 or more and 0.5 or less.

2. The secondary battery according to claim 1, wherein
the solvent further includes ethylene carbonate, propylene carbonate, and monofluoroethylene carbonate,
a content of the propylene carbonate in the solvent is larger than a content of the monofluoroethylene carbonate in the solvent, and
a content of the monofluoroethylene carbonate in the solvent is larger than a content of the ethylene carbonate in the solvent.

3. The secondary battery according to claim 1, wherein
the electrolytic solution further includes succinonitrile and adiponitrile, and
a content of the adiponitrile in the electrolytic solution is larger than a content of the succinonitrile in the electrolytic solution.

4. The secondary battery according to claim 1, wherein the electrolyte salt includes lithium hexafluorophosphate and lithium bis (fluorosulfonyl) imide.

5. The secondary battery according to claim 1, being a lithium ion secondary battery.
